(19) United States
(12) Patent Application Publication
(10) Pub. No.: US 2019/0128336 A1
(43) Pub. Date: May 2, 2019

(54) CLUTCH WITH TORQUE FLOW DISTRIBUTION FOR PARTIAL BOOSTING

(71) Applicant: Schaeffler Technologies AG & Co. KG, Herzogenaurach (DE)

(72) Inventors: Martin CHAMBRION, Erstein (FR); Tim SCHMID, Malsach (DE)

(21) Appl. No.: 16/096,053

(22) PCT Filed: Mar. 17, 2017
(86) PCT No.: PCT/DE2017/100213

§ 371 Date: Oct. 24, 2018

(30) Foreign Application Priority Data
Apr. 27, 2016 (DE) 10 2016 207 116.5

(51) Int. Cl. F16D 13/54; F16D 13/70; F16D 13/68

(52) U.S. Cl. CPC F16D 13/54; F16D 2013/706; F16D 13/683; F16D 13/70

(57) ABSTRACT

A clutch (1), includes an input side (2) which is prepared for the introduction of torque, and an output side (3) which is prepared for the forwarding of torque to at least one transmission input shaft (4). The clutch includes first friction elements (5) as part of a first multiple disc assembly (6) and having second friction elements (7) as part of a second multiple disc assembly (8). The first friction elements (5) are connected to the input side (2) in a torque-transmitting manner and the second friction elements (7) are connected to the output side (3) in a torque-transmitting manner. The first and second friction elements (5, 7) can be brought into frictional engagement with one another by way of a pressing force (F), in order to transmit a torque (M) from the input side (2) to the output side (3). At least one leaf spring (9) is provided which is configured to boost the pressing force (F). The second multiple disc assembly (8) is split and the friction elements (7) thereof are attached to two torque forwarding devices (45, 46) which are separate from one another, in such a way that a torque flow to the transmission input shaft (4) runs via a first torque path (DW1) which contains the at least one leaf spring (9), and a second torque path (DW2) which is separate therefrom.

The present disclosure relates to a clutch, such as a wet multi-disk or multi-plate clutch, for example, possibly of single-clutch type, dual-clutch type or hybrid-clutch type, for a motor vehicle, such as a motor cycle, for example, an automobile, a truck, a tractor or another commercial vehicle, having an input side, which is prepared for the introduction of torque, and an output side, which is prepared for the transfer of torque to at least one transmission input shaft, having first friction elements as part of a first plate pack and second friction elements as part of a second plate pack, wherein the first friction elements, of the (friction) plate type, for instance, are connected to the input side for the transmission of torque, and the second friction elements, of the (steel) plate type, are connected to the output side for the transmission of torque, and wherein the first and second friction elements can be brought into frictional engagement with one another by a contact pressure, in order to transmit a torque from the input side to the output side, wherein at least one leaf spring is provided, which is designed to boost the contact pressure.

Plate clutches are already sufficiently known from the prior art. Thus an international patent application, for example, bearing the application number PCT/DE 2016 200 043, now published on Aug. 25, 2016 as WO2016131450 (A1), discloses a clutch system which comprises an inner plate carrier and an outer plate carrier, which are rotatably supported about an axis of rotation, a first friction element, which is torsionally coupled and fastened to the inner plate carrier so that it is axially displaceable, a second friction element, which is torsionally coupled and fastened to the outer plate carrier so that it is axially displaceable, and an actuating device for providing an axial contact pressure against the friction elements, in order to transmit a torque between the inner plate carrier and the outer plate carrier. In addition, a spring element is provided, which extends helically around the axis of rotation and serves to boost the axial contact pressure as a function of a torque transmitted between the inner plate carrier and the outer plate carrier. The contact pressure is boosted when the spring element is longitudinally under tensile load.

### BACKGROUND

WO 2014/139526 discloses a clutch system comprising an input side and an output side, which are rotatably arranged about an axis of rotation, and at least one first friction element and at least one second friction element, wherein the first friction element is torsionally coupled to the input side, wherein the second friction element is torsionally coupled to the output side, wherein the first and the second friction elements can be brought into frictional engagement by a contact pressure in order to transmit a torque between the input side and the output side, wherein at least one spring means is provided, wherein the spring means is designed to boost the contact pressure.

### SUMMARY OF THE INVENTION

The spring means disclosed by the prior art usually take the form of leaf springs, which because of the angle at which they are set are capable of inherently boosting the contact pressure. The greater the torque transmitted by the leaf springs, the greater the inherent boosting effect. In the prior art, all of the torque that is introduced into the clutch via the input side has hitherto been transmitted via the leaf springs. Thus, although a very great inherent boosting effect can be achieved with a low setting angle of the leaf springs, the stress loading on the leaf springs is therefore also very great. This has the disadvantage that in the event of an impact the buckling resistance of the leaf springs may not be sufficient or the leaf springs may sag prematurely, which leads to slipping of the clutch. This means that the service life of the leaf springs is reduced and the efficiency of the clutch is thereby limited.

An object of the present disclosure is to avoid or at least alleviate the disadvantages inherent in the prior art and in particular, therefore, to provide a clutch in which the leaf spring has to transmit a lesser torque.

A clutch of the generic type is provided in which the second plate pack is divided and the friction elements thereof are attached to two torque transfer devices which are separate from one another, so that a torque flow to the transmission input shaft runs via a first torque path containing at least the one leaf spring and a second torque path which is separate therefrom.

Thus, it is advantageous if the second torque path is designed without any leaf springs. The second torque path can then serve to transmit the proportion of the input torque directly to the transmission input shaft.

The first torque transfer device advantageously comprises a pressure plate and a pressure disk, which are connected to one another for the transmission of torque, and also a support flange, which is connected to the pressure plate and the pressure disk via at least the one a leaf spring for the transmission of torque. These torque-transmitting connections may be positively interlocking, frictional and/or cohesive material connections. These connections are preferably riveted.

The second torque transfer device advantageously comprises a plate carrier and a hub, which are connected to one another for the transmission of torque. Here too, a riveted connection has proved advantageous, but the connection may also be achieved in some other way as a positively interlocking, frictional and/or cohesive material connection.

It has proved advantageous for the plate packs if the first plate pack comprises at least two friction elements which take the form of friction plates, and the second plate pack comprises at least two friction elements which take the form of steel plates.

It is furthermore advantageous if the first torque path runs through a first area of the second plate pack and the first torque transfer device to the transmission input shaft, wherein the first torque transfer device is connected to the first area of the second plate pack by means of the pressure plate for the transmission of torque, and the second torque path runs through a second area of the second plate pack and the second torque transfer device to the transmission input shaft, wherein the second torque transfer device is connected to the second area of the second plate pack by means of the plate carrier for the transmission of torque. This ensures that only a part of the input torque is transmitted to the transmission input shaft via the leaf spring situated in the first torque path, whilst the remainder of the input torque is transmitted directly to the transmission input shaft via the second torque path.

In addition, it has proved advantageous if the leaf spring, at least in the fitted/assembled state, has a setting angle greater than 0° and less than 80°, preferably between 2° and 65°, more preferably between 5° and 50°, and more preferably still between 10° and 45°.

The magnitude of the inherent boosting effect of the clutch depends on the setting angle of the leaf spring and the torque which is introduced into the leaf spring and transmitted by the latter. Here, the greater the setting angle and/or the torque, the greater the inherent boosting effect. This means that for a small torque, for example, the setting angle of the leaf spring needs to be greater than with a larger torque, in order to produce the same inherent boosting effect. Whilst torque is being transmitted via the leaf spring, the latter is subjected to tensile stress.

It has furthermore proved advantageous if the plate carrier is connected to the second area of the plate pack through positive interlock, and the pressure plate is connected to the first area of the second plate pack through positive interlock. The input torque is therefore distributed over the areas of the second plate pack.

It is furthermore advantageous if the plate carrier is positively and/or frictionally connected to the hub, for instance by a rivet. A positively interlocking connection of the pressure plate to the first area of the second plate pack has likewise proved advantageous. For this purpose, the pressure plate preferably has bead-like embossings, which extend into recesses of the plates and thus form a positive interlock with these. It is furthermore advantageous if the plate carrier and the hub are axially fixed.

It has also proved particularly advantageous to provide multiple leaf springs, preferably arranged/designed in the form of a leaf spring pack or multiple leaf spring packs. The pressure plate and the pressure disk are advantageously axially displaceable.

The clutch further comprises a clutch operating gear, which in the exemplary embodiment shown here is prepared for release of the “normally-closed” clutch. In the case of a “normally-open” clutch the clutch operating gear correspondingly serves for closing the clutch. The clutch operating gear in the case of the “normally-open” clutch is therefore also referred to as a clutch engaging gear.

In other words, in the present disclosure, only a proportion of the torque is boosted. This is achieved by dividing the plate carrier into two parts. Only the torque that is taken up by the pressure plate is boosted. Since the torque of the pressure plate is transmitted via the leaf springs, only this torque can be used to produce a boost. For this purpose, at least one steel plate, preferably multiple steel plates, are rotationally fixed to the pressure plate. The pressure plate in turn is connected to the support flange via leaf springs. The support flange is rotationally fixed to the transmission input shaft by a toothing system and is axially fixed by the central nut.

The other steel plates are rotationally fixed to the plate carrier. The plate carrier is riveted to the hub. The hub is rotationally fixed to the transmission input shaft by toothing systems and is axially fixed by the central nut. The disengaging forces and contact pressures here are introduced so that the disengaging force pulls a release collar upwards. The release collar in turns pulls the pressure disk, which is fixed to the leaf springs and the pressure plate, upwards. The plate carrier here therefore does not take up any axial forces. This consequently affords a more direct introduction of the disengaging force, which acts in opposition to the force of the leaf spring. Since less force or torque is transmitted via the leaf springs, these do not need to be as stiff, making it possible to reduce the mass.

To put it another way, a multi-disk clutch in the form of a leaf spring clutch, in particular a motor cycle wet clutch, is proposed, wherein the leaf springs are situated in the torque flow and increase the contact pressure when the combustion engine is in traction mode, wherein the output-side plate carrier is divided into two parts and uses only a proportion of the transmitted torque to increase the contact pressure. The first part of the output-side plate carrier is integrally formed with the pressure plate, on which the clutch operating gear acts. The leaf springs for boosting the contact pressure are anchored in this first part of the output-side plate carrier, so that only the torque via the plates which are rotationally fixed to this first part can be used for boosting the contact pressure. The second part of the output-side plate carrier is fixed to the hub, so that the torque transmitted via these plates is not used for boosting the contact pressure. It is therefore possible to prevent buckling of the leaf springs due to an excessive torque.

### BRIEF SUMMARY OF THE DRAWINGS

The invention is explained in more detail below with the aid of figures in which various embodiments are represented, of which:

FIG. 1 shows a perspective cross sectional view of the clutch;

FIG. 2 shows the perspective cross sectional view of the clutch in FIG. 1, with torque flow drawn in;

FIG. 3 shows a perspective cross sectional view of the clutch, omitting the transmission input shaft and the support flange;

FIG. 4 shows the cross sectional view shown in FIG. 3 further omitting the leaf spring core;

FIG. 5 shows an enlarged detailed view illustrating the different design of the steel plates;

FIG. 6 shows a perspective view of the pressure plate;

FIG. 7 shows a perspective view of the plate carrier;

FIG. 8 shows a perspective view of the support flange;

FIG. 9 shows a perspective view of the pressure disk;

FIG. 10 shows a perspective view of the release collar;

FIG. 11 shows a perspective view of the support ring;

FIG. 12 shows a perspective view of the hub; and

FIG. 13 shows an exploded representation of the main components of the clutch.

The figures are only of a schematic nature and serve only for an understanding of the present disclosure. The same elements are provided with the same reference numerals.

### DETAILED DESCRIPTION

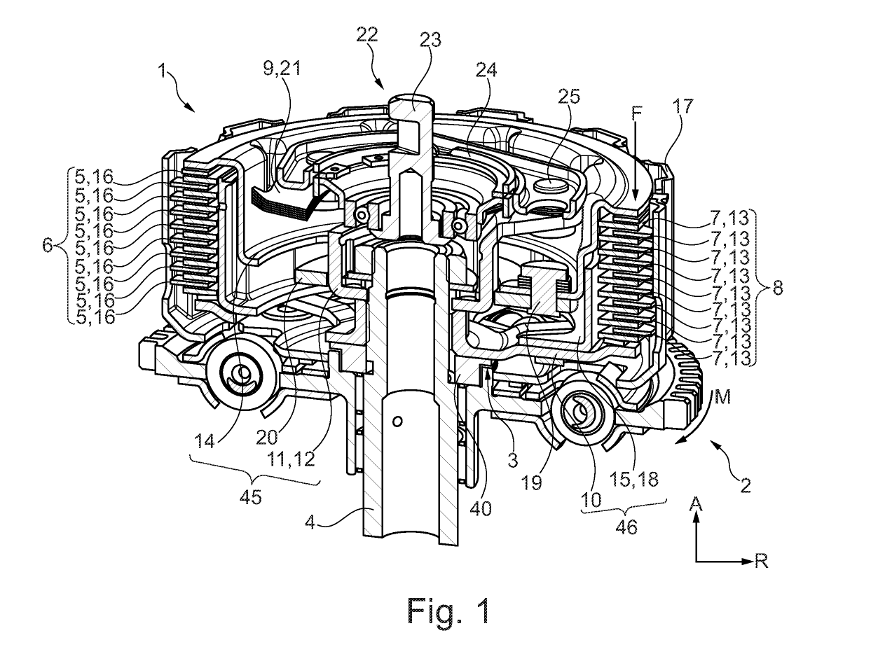

FIG. 1 shows a cross sectional perspective view of the clutch 1. A torque M is introduced into the clutch 1 via an input side 2 and transmitted to a transmission input shaft 4 via an output side 3. For this purpose, the clutch 1 comprises first friction elements 5 as part of a first plate pack 6 and second friction elements 7 as part of a second plate pack 8. The first and second friction elements 5, 7 are arranged alternately and nesting one inside another and can be brought into engagement with one another by a contact pressure F. This contact pressure F can be boosted by a leaf spring 9.

This clutch 1 further comprises a first hub 10 and a second hub 11, the second hub 11 also being referred to as a support flange 12.

In the exemplary embodiment shown here the second plate pack 8 comprises nine second friction elements 7, which take the form, for example, of steel plates 13. The two uppermost steel plates 13 are connected to a pressure plate 14 for the transmission of torque, whereas the remaining seven steel plates 13 are rotationally fixed to a plate carrier 15, which may also be referred to as an inner clutch basket 18. The first hub 10 and the plate carrier 15 therefore form a second torque transfer device 46.

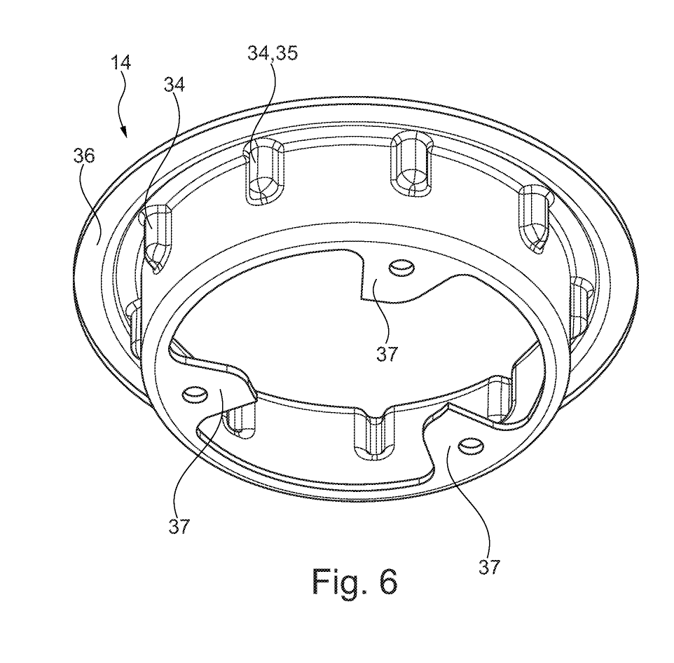

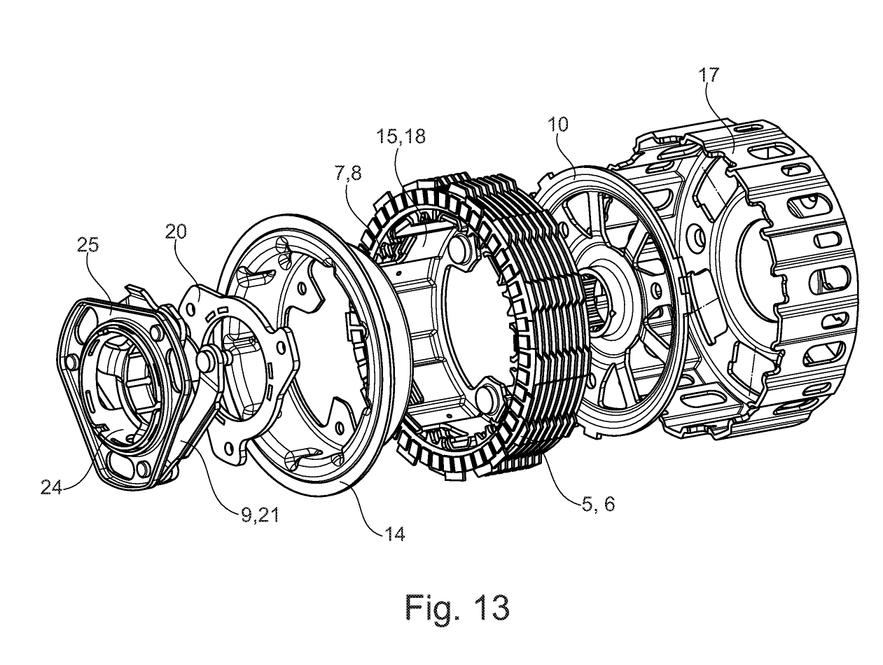

FIG. 13 shows an exploded view of the main components of the clutch 1, which illustrates the geometry of the individual components and how they are assembled. In particular, the geometry of the most important main components or parts of the clutch 1 are represented again separately in the detached views of the corresponding components in FIGS. 6 to 12.

The first plate pack 6 comprises friction plates 16, for example, and is rotationally fixed to an outer clutch basket 17. The pressure plate 14 is fixed to a pressure disk 20 and one end of the leaf spring 9 by a rivet 19. The pressure plate 14, the pressure disk 20, the second hub 11 and/or the support flange 12 therefore form a first torque transfer device 45. The leaf spring 9 here takes the form of a leaf spring pack 21, comprising multiple leaf springs 9. The other end of the leaf spring pack 21 is fixed to the support flange 12 likewise by a rivet (not represented here). The support flange 12 is in turn connected to the transmission input shaft 4 via a conventional shaft-hub connection for the transmission of torque.

The torque transmitted by the two upper steel plates 13 is therefore transmitted to the pressure plate 14 as part of the total torque M. The pressure plate 14 in turn transmits this torque to the leaf spring pack 21 and therefore to the support flange 12 by means of the riveted connection 19. The torque is transmitted to the transmission input shaft 4 via the support flange 12. Due to the loading of the leaf spring pack 21 during the transmission of torque, this presses the pressure plate 14 (and the pressure disk 20) downwards, viewed in an axial direction A, thereby boosting the contact pressure F, which corresponds to an inherent boosting effect of the clutch 1.

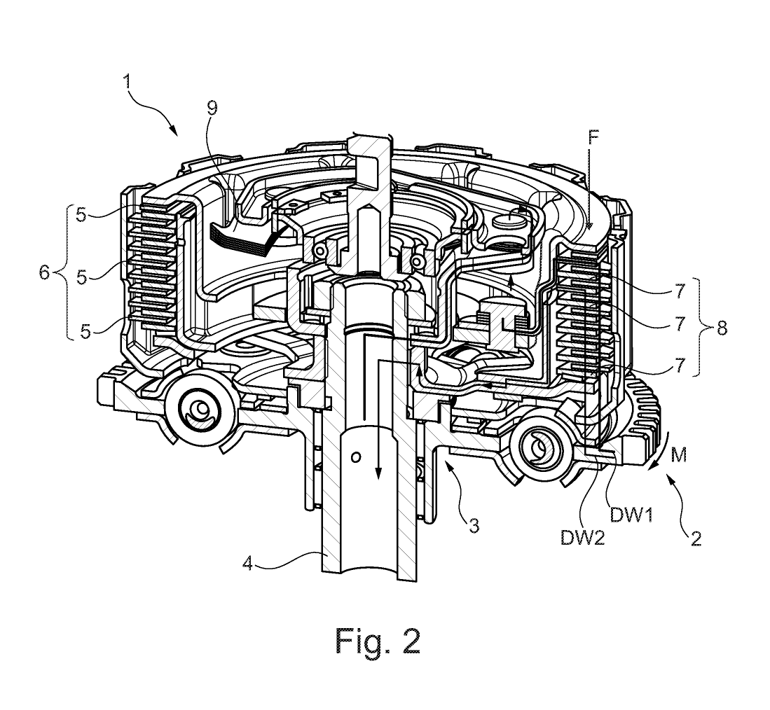

This first torque path DW1 is represented schematically by the thicker arrows in FIG. 2. The remainder of the input torque M is transmitted to the plate carrier 15, which is rotationally fixed to the first hub, via the remaining seven steel plates 13. The first hub 10 is in turn connected to the transmission input shaft via a shaft-hub connection for the transmission of torque, so that the torque passing via a second torque path is transmitted to the transmission input shaft 4 via the first hub 10. This second torque path DW2 is represented schematically by thinner arrows in FIG. 2.

The clutch 1 furthermore has a clutch operating gear 22, comprising a clutch operator 23, a release collar 24 and a support ring 25. If the clutch operating gear 22 is actuated, the clutch operator 23 moves upwards, viewed in an axial direction A, and therefore likewise pulls the release collar 24 upwards. The release collar 24 is connected to the pressure disk 20 (not shown here), so that the upwards movement of the release collar 24 likewise pulls the pressure disk 20 upwards. Since the pressure disk 20 is in turn fixed to the pressure plate 14, the pressure plate is moved upwards in the opposite direction to the contact pressure F, thereby neutralizing the inherent boosting effect of the clutch 1, and the frictional contact between the first friction elements 5 and the second friction elements 7 is furthermore cancelled, so that in this state torque is no longer transmitted from the input side 2 to the output side 3.

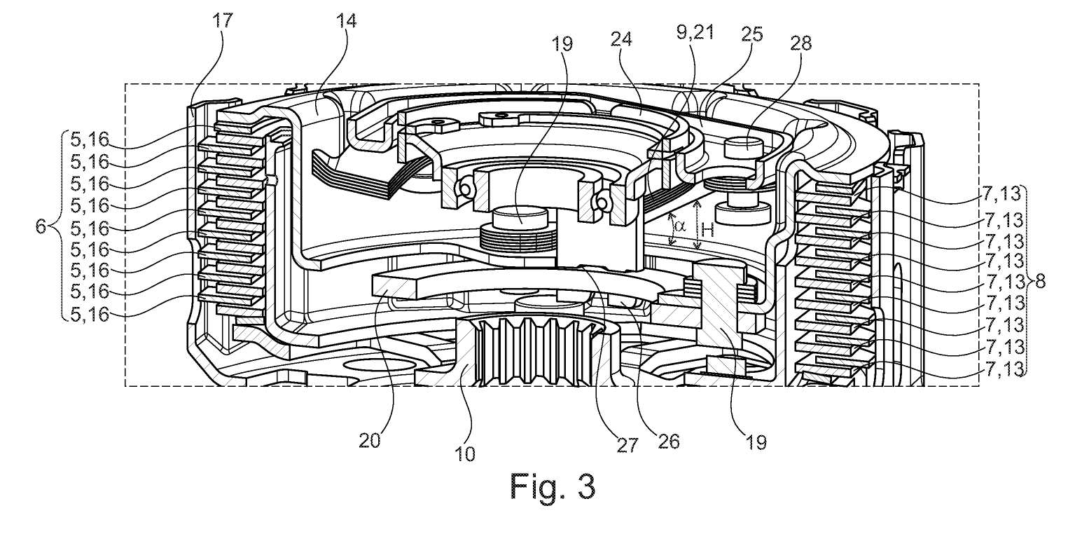

FIG. 3 shows a cross sectional view of the clutch 1 omitting the clutch operator 23, the transmission input shaft 4 and the support flange 12. This view firstly shows the connection between the release collar 24 and the pressure disk 20. The release collar 24 engages by means of interlocking elements 26 in recesses 27 of the pressure plate 20 intended for this purpose. It can further be clearly seen here that for the transmission of torque the leaf spring 9 or the leaf spring pack 21 is connected at one end to the pressure plate 14 by a rivet 19, wherein the rivet 19 furthermore also connects the pressure disk 20 to the pressure plate 14 and the leaf spring 9.

The other end (here situated higher) of the leaf spring 9 is fixed by a rivet 28 to the support flange 12 (not shown here) on the support ring 25. Likewise clearly shown here is the height offset H between the one end of the leaf spring 9 and the other end of the leaf spring 9. This height offset H is usually expressed by an angle to the horizontal, which is referred to as the setting angle α of the leaf spring 9.

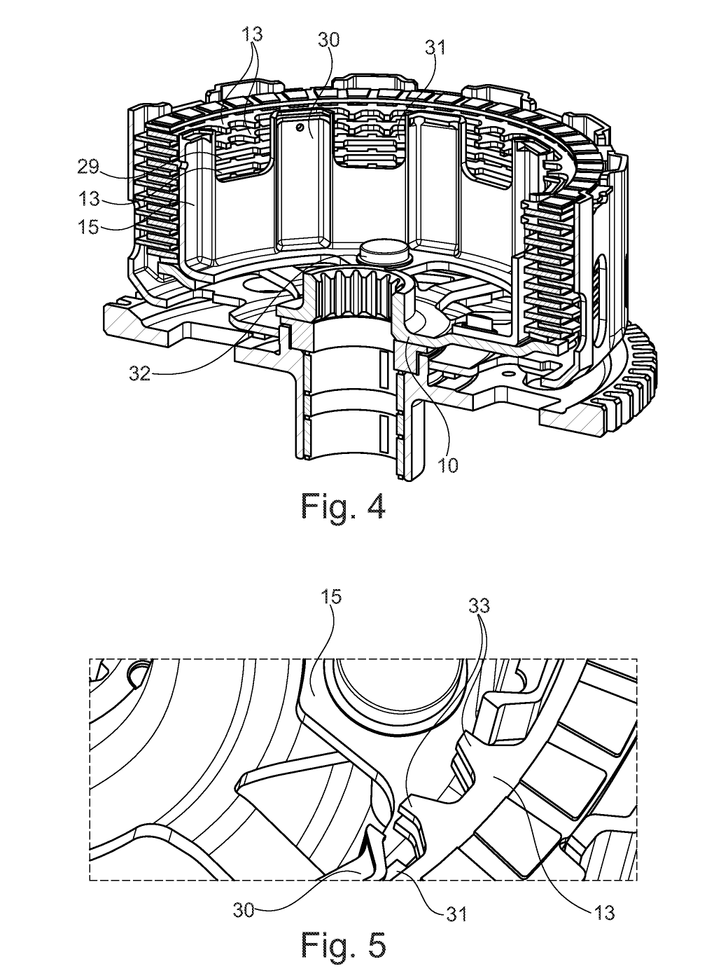

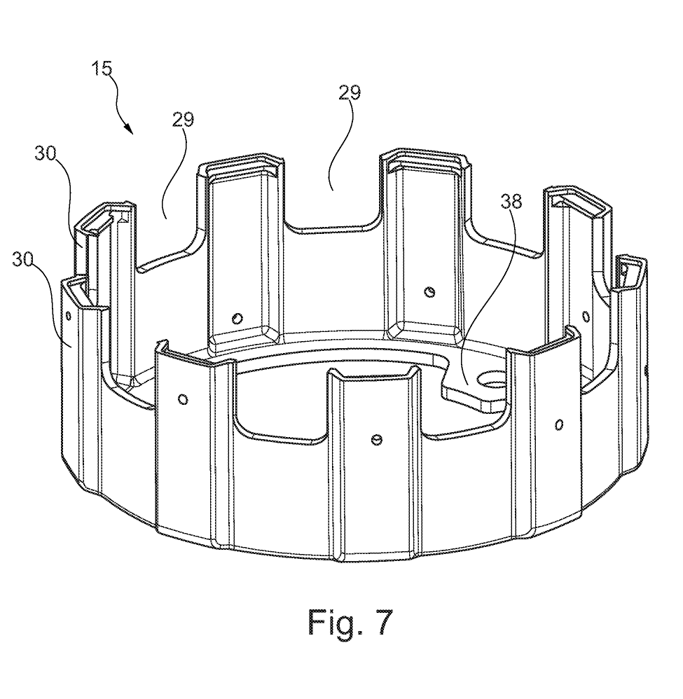

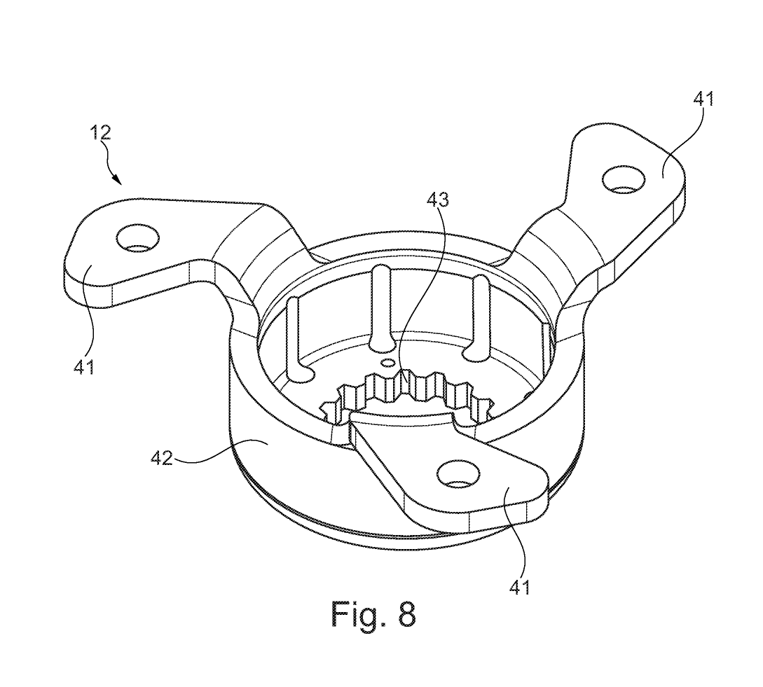

FIG. 4 shows the cross sectional view of the clutch 1 in FIG. 3, further omitting the clutch operating gear 22 and the leaf spring core. It can be seen here that the plate carrier 15 has recesses 29, which are formed so that the two uppermost steel plates 13 are able to interlock positively with the pressure plate 14. The plate carrier 15 furthermore has embossings 30, which protrude outwards in a radial direction (see also FIG. 7).

The steel plates 13, which are connected to the plate carrier 15 for the transmission of torque, are formed so that in a circumferential direction they comprise lugs 31, which protrude inwards in a radial direction R. These lugs 31 are formed so that every two lugs 31 receive an embossing 30 of the plate basket 15, 18 in a positive interlock between them, or so that the embossing 30 interlocks positively in the area between two lugs 31. The plate carrier 15 is fixed to the hub 10 by a riveted connection 32.

It can be seen at the bottom edge in FIG. 5 that the lug 31 bears externally on the embossing 30 of the bearing carrier 15. It can furthermore clearly be seen here that the two upper steel plates 13 project or extend into the recess 29 of the plate carrier 15 and likewise comprise lugs 33, which point radially inwards and in the gap between which an embossing 34 (see FIG. 6) of the pressure plate 14 positively interlocks.

FIG. 6 shows a perspective view of the pressure plate 14. As already described above, this has embossings 34, which are preferably distributed equally over the circumference, and in the embodiment shown here take the form of a bead 35, for example. The pressure plate 14 furthermore has an edge area 36, which in the assembled state of the clutch 1 serves as bearing surface against the plate packs 6, 8. In addition, the pressure plate 14 comprises multiple fastening flanges 37, which serve for attachment to the leaf spring 9 and to the pressure disk 20 (see FIG. 1).

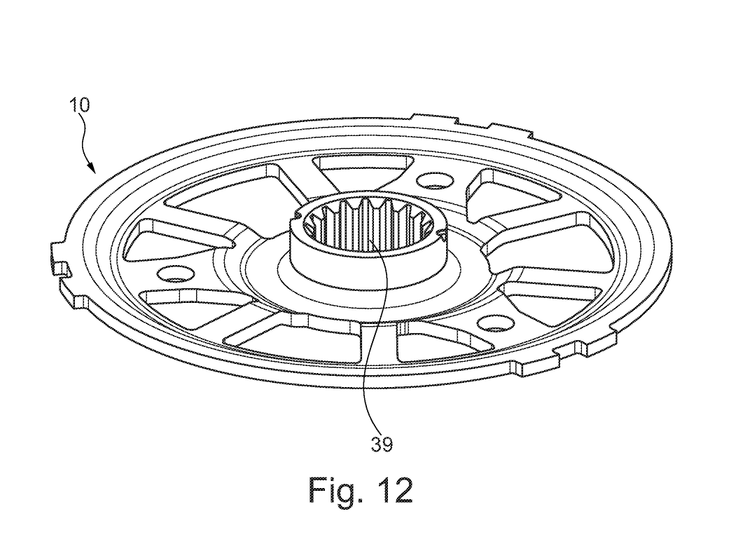

FIG. 7 shows a detached perspective view of the plate carrier 15. Clearly shown here are the embossings 30, which are preferably distributed equally over the circumference. Situated between the respective embossings 30 are the recesses 29, which are necessary in order to be able to connect the upper steel plates 13 to the pressure plate 14 for the transmission of torque. The plate carrier 15 further comprises one and preferably more fastening flanges 38, via which it is fixed to the hub 10 (see also FIG. 12) by means of a riveted connection.

The hub 10, as can be seen in FIG. 12, has an inwardly toothed geometry 39 at its center, which meshes in a matching negative geometry of the transmission input shaft 4, on the principle of a conventional shaft/hub connection, and consequently transmits the torque to the transmission input shaft 4. The hub 10 is fixed in an axial direction by a central nut 40 (see FIG. 1), and thus fulfills the function of a counterplate, so that in the embodiment shown here a (separate) counterplate is dispensed with.

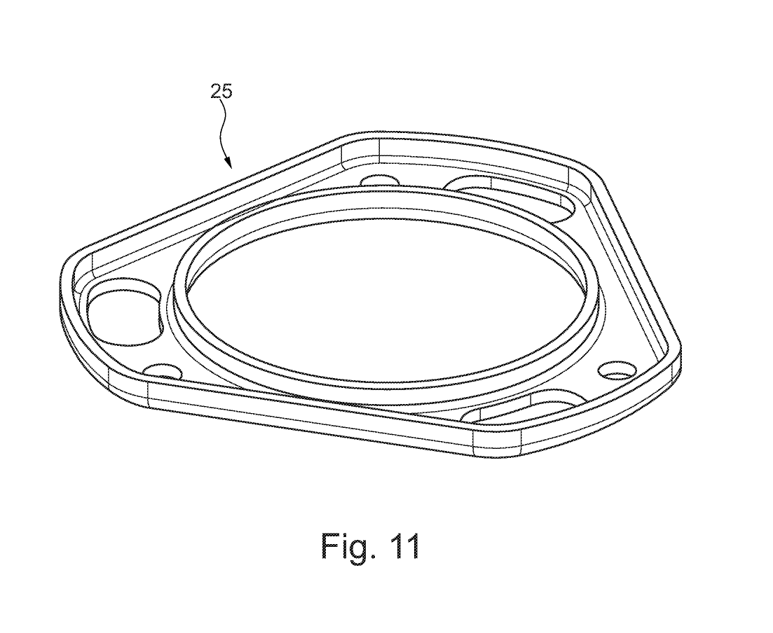

FIG. 8 shows a perspective representation of the support flange 12. This comprises fastening flanges 41 evenly distributed over the circumference, by means of which it is connected to the leaf spring 9 or the leaf spring pack 21 and the support ring 25 (see also FIG. 11) by riveted connections. The main body 42 of the support flange 12 is of cupped formation and like the hub 10 (see also FIG. 12) has a toothed geometry 43 in the center, via which it is connected to the transmission input shaft 4 by means of a conventional shaft-hub connection for the transmission of torque.

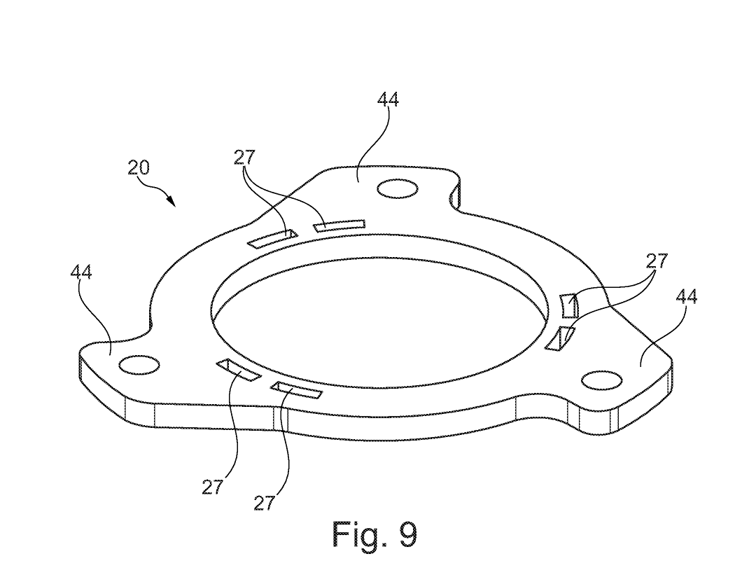

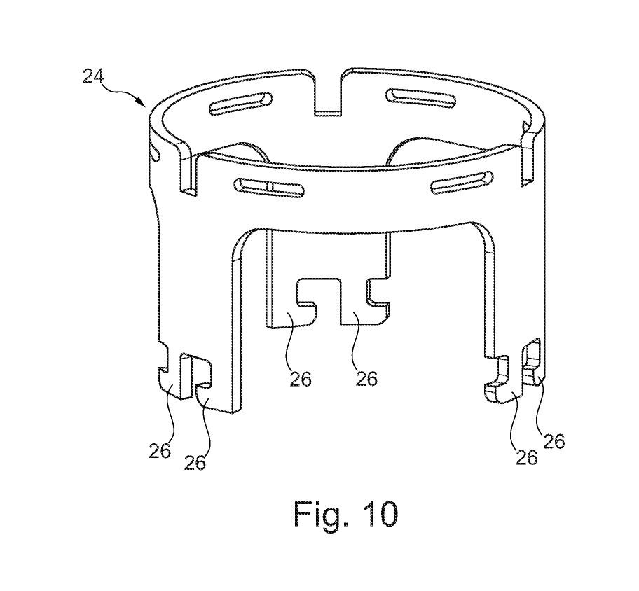

FIG. 9 shows a detached perspective view of the pressure disk 20. The pressure disk is of substantially annular formation and comprises fastening flanges 44, protruding outwards in a radial direction and equally distributed over its circumference, via which the pressure disk 20 is connected to the pressure plate 14 or the leaf spring 9 by means of a riveted connection. The pressure disk 20 further comprises rectangular recesses 27, in which interlocking elements 26 of the release collar 24 (see also FIG. 10) positively interlock.

### LIST OF REFERENCE NUMERALS

1 clutch
2 input side
3 output side
4 transmission input shaft
5 first friction element
6 first plate pack
7 second friction element
8 second plate pack
9 leaf spring
10 first hub
11 second hub
12 support flange
13 steel plate
14 pressure plate
15 plate carrier
16 friction plate
17 outer clutch basket
18 inner clutch basket
19 rivet
20 pressure disk
21 leaf spring pack
22 clutch operating gear
23 clutch operator
24 release collar
25 support ring
26 interlocking element
27 recess
28 rivet
29 recess
30 embossing
31 lug
32 rivet
33 lug
34 embossing
35 bead
36 edge area
37 fastening flange
38 fastening flange
39 toothed geometry
40 central nut
41 fastening flange
42 main body
43 toothed geometry
44 fastening flange
45 first torque transfer device
46 second torque transfer device
M torque
F contact pressure
A axial direction
R radial direction
DW1 torque path 1
DW2 torque path 2
H height offset
α setting angle

What is claimed is:

1-9. (canceled)

10. A clutch having an input side for an introducing torque and an output side for a transferring torque to a transmission input shaft, the clutch comprising:
first friction elements as part of a first plate pack;
second friction elements as part of a second plate pack, the first friction elements being connected to the input side for torque transmission and the second friction elements are connected to the output side for the torque transmission, the first and second friction elements configured for being brought into frictional engagement with one another by a contact pressure in order to transmit a torque from the input side to the output side; and
at least one leaf spring configured to boost the contact pressure, the second plate pack being divided and the second friction elements being attached to a first torque transfer device and a second torque transfer device, the first torque transfer device and the second torque transfer device being separate from one another so that a torque flow to the transmission input shaft runs via a first torque path containing at least the one leaf spring and a second torque path separate from the first torque path.

11. The clutch as claimed in claim 10, wherein the second torque path does not include any leaf springs.

12. The clutch as claimed in claim 10, wherein the first torque transfer device includes a pressure plate and a pressure disk connected to one another for torque transmission, the first torque transfer device also including a support flange connected to the pressure plate and the pressure disk by at least the at least one leaf spring for torque transmission.

13. The clutch as claimed in claim 12, wherein the second torque transfer device includes a plate carrier and a hub connected to one another for torque transmission.

14. The clutch as claimed in claim 13, wherein the first torque path runs through a first area of the second plate pack and the first torque transfer device to the transmission input shaft, the first torque transfer device being connected to the first area of the second plate pack by the pressure plate for torque transmission, the second torque path running through a second area of the second plate pack and the second torque transfer device to the transmission input shaft, the second torque transfer device being connected to the second area of the second plate pack by the plate carrier for torque transmission.

15. The clutch as claimed in claim 14 wherein the second plate pack includes at least one first area plate and at least one second area plate, the at least one first area plate being connected to the pressure plate for torque transmission, the at least one second area plate being connected to the plate carrier for torque transmission.

16. The clutch as claimed in claim 15 wherein the at least one first area plate includes lugs for engaging embossments of the pressure plate for torque transmission and the at least one second area plate includes lugs for engaging embodiments of the plate carrier for torque transmission.

17. The clutch as claimed in claim 14, wherein the plate carrier is connected to the second area of the second plate pack through positive interlock.

18. The clutch as claimed in claim 14, wherein the pressure plate is connected to the first area of the second plate pack through positive interlock.

19. The clutch as claimed in claim 13 wherein an axially extending portion of the plate carrier is radially outside of an axially extending portion of the pressure plate.

20. The clutch as claimed in claim 10, wherein the first friction elements are friction plates and the second friction elements are steel plates.

21. The clutch as claimed in claim 10, wherein the leaf spring, at least in a fitted state, has a setting angle greater than 0° and less than 80°.

22. The clutch as claimed in claim 10 wherein the first torque path flows through all of the second friction elements and the second torque path flows through only some of the second friction elements.

23. The clutch as claimed in claim 10 wherein the first torque transfer device and the second torque transfer device are configured for being directly connected to the transmission input shaft.

24. A method of constructing a clutch having an input side for an introducing torque and an output side for a transferring torque to a transmission input shaft, the method comprising:
connecting first friction elements of a first plate pack to the input side for torque transmission;
connecting second friction elements of a second plate pack to the output side for the torque transmission, the second plate pack being divided;
arranging the first and second friction elements for being brought into frictional engagement with one another by a contact pressure in order to transmit a torque from the input side to the output side;
attaching the second friction elements to a first torque transfer device and a second torque transfer device; and
providing at least one leaf spring configured to boost the contact pressure, the first torque transfer device and the second torque transfer device being separate from one another so that a torque flow to the transmission input shaft runs via a first torque path containing at least the one leaf spring and a second torque path separate from the first torque path.

25. The method as claimed in claim 24, wherein the first torque transfer device includes a pressure plate and a pressure disk connected to one another for torque transmission, the first torque transfer device also including a support flange connected to the pressure plate and the pressure disk by at least the at least one leaf spring for torque transmission.

26. The method as claimed in claim 25, wherein the second torque transfer device includes a plate carrier and a hub connected to one another for torque transmission.

27. The method as claimed in claim 26, wherein the first torque path runs through a first area of the second plate pack and the first torque transfer device to the transmission input shaft, the first torque transfer device being connected to the first area of the second plate pack by the pressure plate for torque transmission, the second torque path running through a second area of the second plate pack and the second torque transfer device to the transmission input shaft, the second torque transfer device being connected to the second area of the second plate pack by the plate carrier for torque transmission.
